(19) United States
(12) Patent Application Publication
(10) Pub. No.: US 2012/0122665 A1
(43) Pub. Date: May 17, 2012

(54) MULTI-METALLIC CATALYST WITH A STRONG METALLIC INTERACTION

(75) Inventors: Priscilla Avenier, Grenoble (FR); Sylvie Lacombe, Vernaison (FR); Jean Claude Jumas, Jacou (FR); Josette Olivier-Fourcade, Jacou (FR)

(73) Assignee: IFP ENERGIES NOUVELLES, rueil-malmaison cedex (FR)

(21) Appl. No.: 13/381,394

(22) PCT Filed: Jun. 15, 2010
(86) PCT No.: PCT/FR2010/000444

§ 371 Date: Jan. 31, 2012

(30) Foreign Application Priority Data
Jul. 1, 2009 (FR) 09/03 225

(51) Int. Cl. B01J 27/185; B01J 27/186

(52) U.S. Cl. 502/213

(57) ABSTRACT

The invention concerns a catalyst comprising at least one metal M from group VIII, tin, a phosphorus promoter, a halogenated compound, a porous support and at least one promoter X1 selected from the group constituted by gallium, indium, thallium, arsenic, antimony and bismuth. In ¹¹⁹Sn Mössbauer spectroscopy, the catalyst in the reduced form has a signal with a quadripole splitting value in the range 0 to 0.45 mm/s and an isomer shift, IS, in the range 1.5 to 2.4 mm/s with respect to CaSnO₃, said signal representing in the range 1% to 30% of the total area of the signals.

### FIELD OF THE INVENTION

The present invention relates to the field of hydrocarbon conversion, and more specifically to reforming hydrocarbon feeds in the presence of a catalyst to produce gasoline cuts. The invention also relates to improved catalytic formulations based on at least one metal from the platinum group for use in said conversion, as well as to their mode of preparation.

### PRIOR ART

Many patents describe adding promoters to platinum-based catalysts in order to improve their performance as regards hydrocarbon feed reforming. Thus, U.S. Pat. No. 2,814,599 describes adding promoters such as gallium, indium, scandium, yttrium, lanthanum, thallium or actinium to catalysts based on platinum or palladium. U.S. Pat. No. 4,522,935 describes reforming catalysts comprising platinum, tin, indium and a halogenated compound deposited on a support in which the indium/platinum atomic ratio is more than 1.14.

Patent FR 2 840 548 describes a catalyst in the form of a homogeneous bed of particles comprising an amorphous matrix, at least one noble metal, at least one halogen and at least one additional metal. Said additional metal is preferably selected from the group constituted by tin, germanium, lead, gallium, indium, thallium, rhenium, manganese, chromium, molybdenum and tungsten.

Phosphorus is also known to increase the yields of hydrocarbon compounds containing strictly more than 4 carbon atoms (C5+), in particular aromatic products. That property is claimed in U.S. Pat. No. 2,890,167, U.S. Pat. No. 3,706,815, U.S. Pat. No. 4,367,137, U.S. Pat. No. 4,416,804, U.S. Pat. No. 4,426,279 and U.S. Pat. No. 4,463,104. More recently, patent US 2007/0215523 described that adding diluted quantities of phosphorus, less than 1% by weight, stabilizes the support by allowing better retention of specific surface area and chlorine during its use in catalytic reforming processes.

The U.S. Pat. No. 6,864,212 and U.S. Pat. No. 6,667,270 describe a support containing bismuth and phosphorus distributed in a homogeneous manner and used for the preparation of a catalyst for the catalytic reforming of hydrotreated naphtha. According to those patents, adding bismuth alone to the support can slow down the formation of coke and the decline in activity, but the C5+ yield is reduced at the same time, while adding phosphorus alone increases that yield without improving the stability of the catalyst. The combination of those two elements can further slow coke formation down while at the same time having better selectivities for Bi contents in the range 0.10% to 0.06% by weight, and a P content of 0.3% by weight. Those two patents do not claim other elements.

Further, in patent EP 1 656 991, a catalyst comprising platinum, tin, a high density support composed of at least one inorganic oxide including alumina and phosphate, and optionally another element selected from germanium, gallium, rhenium, phosphorus, indium or a mixture thereof, is characterized in that at least 33% by weight of tin is associated with the platinum in the form of a specific Pt—Sn cluster observed using Mössbauer spectroscopy. The importance of that catalyst resides in the increase in its stability and minimization of the production of coke with respect to catalysts which are known in the art.

### SUMMARY OF THE INVENTION

The invention concerns a catalyst comprising at least one metal M from group VIII, tin, a phosphorus promoter, a halogenated compound, a porous support and at least one promoter X1 selected from the group constituted by gallium, indium, thallium, arsenic, antimony and bismuth. In ¹¹⁹Sn Mössbauer spectroscopy, the catalyst in the reduced form has a signal with a quadripole splitting value in the range 0 to 0.45 mm/s and an isomer shift, IS, in the range 1.5 to 2.4 mm/s with respect to CaSnO₃, said signal representing in the range 1% to 30% of the total area of the signals.

### DETAILED DESCRIPTION OF THE INVENTION

The invention concerns a catalyst comprising at least one metal M from the platinum group, tin, a phosphorus promoter, a halogenated compound, a porous support and at least one promoter X1 selected from the group constituted by gallium, indium, thallium, arsenic, antimony and bismuth, preferably from the group constituted by gallium, thallium, indium and bismuth, highly preferably from the group constituted by gallium and indium, and still more preferably the promoter X1 is indium, said catalyst in the reduced form having, in ¹¹⁹Sn Mössbauer spectroscopy, a signal with a quadripole splitting value in the range 0 to 0.45 mm/s and an isomer shift, IS, in the range 1.5 to 2.4 mm/s with respect to CaSnO₃, said signal representing in the range 1% to 30% of the total area of the signals, preferably in the range 4% to 20%.

The catalysts of the invention produce improved catalytic performances. In particular, the selectivity of said catalysts is increased towards the formation of C5+ compounds (i.e. compounds comprising at least 5 carbon atoms), while coke formation is substantially reduced.

The catalyst preparation process comprises a step for introducing phosphorus and the promoter or promoters X1 during a support preparation step.

The atomic ratio Sn/M is generally in the range 0.5 to 4.0, more preferably in the range 1.0 to 3.5, and highly preferably in the range 1.3 to 3.2. The ratio X1/M is generally in the range 0.1 to 5.0, more preferably in the range 0.2 to 3.0, and highly preferably in the range 0.4 to 2.2. The ratio P/M is generally in the range 0.2 to 30.0, more preferably in the range 0.5 to 20.0, and highly preferably in the range 1.0 to 15.0. The quantity of metal M is generally in the range 0.01% to 5% by weight, more preferably in the range 0.01% to 2% and still more preferably in the range 0.1% to 1% by weight.

The metal M is generally platinum or palladium, highly preferably platinum. The halogenated compound is generally selected from the group constituted by fluorine, chlorine, bromine and iodine. The quantity of halogenated compound is generally in the range 0.1% to 15.0% by weight, more preferably in the range 0.1% to 8.0% by weight, still more preferably in the range 0.2% to 5% by weight. If the halogenated compound is chlorine, the quantity of chlorine is generally in the range 0.0 to 5.0% by weight, preferably in the range 0.5% to 2.0% by weight.

The analyses which can be used to determine the local electronic structure of the tin were carried out using conventional Mössbauer spectroscopy with the aid of a Ba^{119m}SnO₃ source of y radiation with a nominal activity of 10 mCi. The spectrometer operated in transmission mode with a constant acceleration motion generator functioning in triangular mode with a 512 channel analyzer controlled by a microprocessor. The detector was a NaI crystal (T1) 0.1 mm thick. The scale was calibrated using a standard 6-line spectrum of a iron obtained with a ⁵⁷Co(Rh) source. All of the isomer shifts are given with respect to CaSnO₃. ISO software was used to deconvolute the experimental spectra into Lorentzian profiles and to determine the various parameters (W. Künding, Nucl Instrum Method, 75, 336 (1969)).

In ¹¹⁹Sn Mössbauer spectroscopy, the catalyst in the reduced form of the invention generally has a signal exhibiting a quadripole splitting value in the range 0 to 0.45 mm/s, and an isomer shift, IS, in the range 1.5 to 2.4 mm/s with respect to CaSnO₃, said signal representing in the range 1% to 30% of the total area of the signals, preferably in the range 4% to 20%.

According to the attributions published by J Olivier Fourcade et al, in ChemPhysChem 2004, 5, 1734, the preparation process thus involves, on the reduced catalyst, the formation of species of tin, Sn⁰, alloyed to a portion of the metal atoms from the platinum group. The alloy MₓSn_{y} thus observed is indicative of a very strong interaction between the atoms of the metal from the platinum group and tin.

The support generally comprises at least one oxide selected from the group constituted by oxides of magnesium, titanium, zirconium, aluminium and silicon. Preferably, it is silica, alumina or silica-alumina, and highly preferably alumina. According to the invention, said porous support is advantageously in the form of beads, extrudates, pellets or powder. Highly advantageously, said support is in the form of beads or extrudates. The pore volume of the support is preferably in the range 0.1 to 1.5 cm³/g, more preferably in the range 0.4 to 0.8 cm³/g. Further, said porous support has a specific surface area which is advantageously in the range 50 to 600 m²/g, preferably in the range 100 to 400 m²/g, or even in the range 150 to 300 m²/g.

The process for the preparation of the catalyst of the invention generally comprises the following steps:
a) introducing the promoter or promoters X1 and phosphorus during one of sub-steps a1) or a2), said sub-step a1) corresponding to synthesis of a precursor of the main oxide, said sub-step a2) corresponding to shaping the support;
b) introducing tin during at least one of the sub-steps a1) and a2), the steps a) and b) possibly being consecutive or simultaneous;
c) drying the product obtained at the end of step b);
d) calcining the product obtained in step c) at a temperature in the range 350° C. to 650° C.;
e) depositing at least one metal M from the platinum group;
f) drying in a stream of neutral gas or a stream of gas containing oxygen, at a moderate temperature not exceeding 150° C.;
g) calcining the product obtained in step f) at a temperature in the range 350° C. to 650° C.

The tin may only be introduced in part when shaping the support, the process then comprising a supplemental step for depositing a complementary fraction of tin onto the support, either between steps d) and e), followed or otherwise by drying and calcining, or between steps e) and f), or after step g), followed by drying and calcining.

The calcining of step g) is generally carried out in the presence of air, optionally enriched with oxygen or nitrogen.

The promoters X1, P and Sn may be introduced using any technique which is known to the skilled person. During their introduction into the support, the promoters X1, P and Sn may be added by mixing, co-precipitating or dissolving; these methods are not limiting.

Thus, introduction of the tin may be simultaneous or may take place separately, before or after that for the precursors X1 and P.

In the case of introducing the promoter or promoters X1 and phosphorus, i.e. during synthesis of the oxide precursor, in accordance with a preferred method for preparation in accordance with the invention, the tin, phosphorus and the precursor or precursors X1 are introduced during synthesis of the precursor of the main oxide using a sol-gel type technique.

In accordance with another preferred method, the precursors are added to a prepared sol of a main oxide precursor. The support is shaped using prior art support shaping techniques, such as shaping procedures involving extrusion or oil drop coagulation.

The X1 precursors are of a plurality of types depending on the nature of X1 and may be used alone or as a mixture. In the case of indium, indium halides, nitrates, sulphates, perchlorate, cyanide or hydroxide are suitable. Precursors of the gallium halide, nitrate, sulphate, cyanide, hydroxide and oxyhalide type may be used. Thallium may be introduced in the form of thallium nitrates, sulphates and hydroxide. In the case of antimony, antimony nitrates, sulphates and hydroxide are suitable. Precursors of arsenic halides and oxyhalides may be used. Bismuth may be introduced in the form of bismuth halides, nitrates, hydroxide, oxyhalides or carbonate, or as bismuthic acid.

The tin precursors may be minerals or may be organometallic in type, possibly of the hydrosoluble organometallic type. Various precursors may be used, alone or as a mixture. In particular, tin may be selected; in a non-limiting manner, the tin may be selected from the group formed by halogenated, hydroxide, carbonate, carboxylate, sulphate, tartrate and nitrate compounds. These forms of tin may be introduced into the catalyst preparation medium as they are or they may be generated in situ (for example by introducing tin and carboxylic acid). Examples of organometallic tin-based type precursors are SnR₄, where R represents an alkyl group, for example the butyl, Me₃SnCl, Me₂SnCl₂, Et₃SnCl, Et₂SnCl₂, EtSnCl₃, iPrSnCl₂ group, and the hydroxides Me₃SnOH, Me₂Sn(OH)₂, Et₃SnOH, Et₂Sn(OH)₂, the oxides (Bu₃Sn)₂O, the acetate Bu₃SnOC(O)Me. Preferably, halogenated species, in particular chlorinated species of tin, are used. In particular, SnCl₂ or SnCl₄ are advantageously used.

Having introduced the promoters Sn, X1 and P into the support or onto the support that has already been shaped in the case of tin, the protocol for preparing the catalysts of the invention necessitates calcining before depositing the metal M from the platinum group (step d). Said calcining is preferably carried out at a temperature in the range 350° C. to 650° C., preferably in the range 400° C. to 600° C. and more preferably in the range 400° C. to 550° C. The temperature rise may be regular, or may include intermediate constant temperature stages, said stages being reached with fixed or variable temperature profiles. These rises in temperature may thus be identical or differ in their rate (in degrees per minute or per hour). The gas atmosphere used during calcining contains oxygen, preferably in the range 2% to 50% by volume and more preferably in the range 5% to 25%. Air may thus also be used during this calcining step.

After obtaining the support, at least one metal M from the platinum group is deposited (step e). In this step, the metal M may be introduced by dry impregnation or excess solution impregnation, using a precursor or a mixture of precursors containing a metal M from the platinum group. Impregnation may be carried out in the presence of species acting on the interaction between the precursor of the metal M and the support. In a non-limiting manner, said species may be mineral acids (HCl, HNO₃) or organic acids (carboxylic or polycarboxylic acid types), and organic complexing type compounds. Preferably, impregnation is carried out using any technique which is known to the skilled person for obtaining a homogeneous distribution of the metal M within the catalyst.

The precursors of the metal M form part of the following group, although this list is not limiting: hexachloroplatinic acid, bromoplatinic acid, ammonium chloroplatinate, platinum chlorides, platinum dichlorocarbonyl dichloride, and platinum tetramine chloride.

At this stage, the catalyst containing X1, Sn, P and platinum is dried (step f), in a neutral atmosphere or an atmosphere containing oxygen (air may be used), at a moderate temperature which preferably does not exceed 250° C. Preferably, drying is carried out at a temperature of 200° C. or less and over a period of a few minutes to a few hours.

This step is then followed by calcining the product obtained in step f). Said calcining is preferably carried out in the presence of air. This air may also be enriched in oxygen or nitrogen. Preferably, the oxygen content in said gas reaches 0.5% to 30.0% by volume, more preferably in the range 2% to 25%.

Said calcining is carried out at a temperature in the range 350° C. to 650° C., preferably in the range 400° C. to 650° C., and more preferably in the range 450° C. to 550° C. The temperature profile may optionally contain constant temperature stages.

When the various precursors used in the preparation of the catalyst of the invention do not contain halogen or contain halogen in insufficient quantities, it may be necessary to add a halogenated compound during the preparation. Any compound which is known to the skilled person may be used and incorporated into any one of the steps for the preparation of the catalyst of the invention. In particular, it is possible to use compounds of the Friedel-Crafts type such as aluminium chloride or bromide. It is also possible to use organic compounds such as methyl or ethyl halides, for example dichloromethane, chloroform, dichloroethane, methyl chloroform or carbon tetrachloride.

The chlorine may also be added to the catalyst of the invention using an oxychlorination treatment. Said treatment may, for example, be carried out at 500° C. for 4 hours in a flow of air containing the quantity of gaseous chlorine necessary to deposit the desired quantity of chlorine and a quantity of water with a H₂O/Cl molar ratio close to 20, for example.

The chlorine may also be added by means of impregnation with an aqueous hydrochloric acid solution. A typical protocol consists of impregnating the solid so as to introduce the desired quantity of chlorine. The catalyst is maintained in contact with the aqueous solution for a period sufficiently long to deposit this quantity of chlorine, then the catalyst is drained and dried at a temperature in the range 80° C. to 150° C., then finally calcined in air at a temperature in the range 450° C. to 650° C.

Typically, the catalyst undergoes a reduction treatment. This reduction step is generally carried out in a dilute or pure hydrogen atmosphere and at a temperature advantageously in the range 400° C. to 600° C., preferably in the range 450° C. to 550° C.

### EXAMPLES

The following examples illustrate the invention.

### Example 1

### Comparative

### Preparation of a Catalyst A

### Pt/(Al₂O₃—Sn)—Cl

A support in the form of alumina beads containing 0.3% by weight of tin and with a mean diameter of 1.2 mm was prepared by bringing tin dichloride into contact with an alumina hydrosol obtained by hydrolysis of aluminium chloride. The alumina hydrosol obtained thereby was then passed into a vertical column filled with additive oil. The spheres thus obtained were heat treated at up to 600° C. in order to obtain beads with good mechanical strength. The support obtained thereby had a BET surface of 205 m²/g.

A catalyst A was prepared on this support by depositing 0.3% by weight of platinum and 1% by weight of chlorine onto the final catalyst. 400 cm³ of an aqueous solution of hexachloroplatinic acid and hydrochloric acid was added to 100 g of alumina support containing tin. It was left in contact for 4 hours then drained. It was dried at 120° C. then calcined for 2 hours at 500° C. in a flow of air of 100 litres per hour, with a temperature ramp-up of 7° C. per minute. The catalyst A obtained after calcining contained 0.29% by weight of platinum, 0.30% by weight of tin and 1.02% by weight of chlorine.

### Example 2

### Comparative

### Preparation of a Catalyst B

### Pt/(Al₂O₃—Sn—In)—Cl

A support in the form of alumina beads containing 0.3% by weight of tin and 0.3% by weight of indium with a mean diameter of 1.2 mm was prepared by bringing tin dichloride and indium nitrate into contact with an alumina hydrosol obtained by hydrolysis of aluminium chloride. The alumina hydrosol obtained thereby was then passed into a vertical column filled with additive oil. The spheres thus obtained were heat treated at up to 600° C. in order to obtain beads with good mechanical strength. The support obtained thereby had a BET surface of 201 m²/g.

A catalyst B was prepared on this support, aiming for the same platinum and chlorine contents as in Example 1. The catalyst B obtained after calcining contained 0.29% by weight of platinum, 0.29% by weight of tin, 0.30% by weight of indium and 1.05% by weight of chlorine.

### Example 3

### Comparative

### Preparation of a Catalyst C

### Pt/(Al₂O₃—Sn—P)—Cl

A support in the form of alumina beads containing 0.3% by weight of tin and 0.4% by weight of phosphorus and with a mean diameter of 1.2 mm was obtained in a manner similar to that described in Example 1 by bringing tin dichloride and phosphoric acid into contact with an alumina hydrosol The support obtained thereby had a BET surface of 198 m²/g.

A catalyst C was prepared on this support, aiming for the same platinum and chlorine contents as in Example 1. The catalyst C obtained after calcining contained 0.30% by weight of platinum, 0.31% by weight of tin, 0.39% by weight of phosphorus and 1.00% by weight of chlorine.

### Example 4

### In Accordance with the Invention

### Preparation of a Catalyst D

### Pt/(Al₂O₃—Sn—In—P)—Cl

A support in the form of alumina beads containing 0.3% by weight of tin, 0.3% by weight of indium and 0.4% by weight of phosphorus and with a mean diameter of 1.2 mm was obtained in a manner similar to that described in Example 1 by bringing tin dichloride, indium nitrate and phosphoric acid into contact with an alumina hydrosol The support obtained thereby had a BET surface of 196 m²/g.

A catalyst D was prepared on this support, aiming for the same platinum and chlorine contents as in Example 1. The catalyst D obtained after calcining contained 0.30% by weight of platinum, 0.31% by weight of tin, 0.32% by weight of indium, 0.38% by weight of phosphorus and 1.00% by weight of chlorine.

### Example 5

### In Accordance with the Invention

### Preparation of a Catalyst E

### Pt/(Al₂O₃—Sn—In—P)—Cl

A support in the form of alumina beads was prepared in the same manner as in Example 4, with the same quantities of tin and phosphorus, but only introducing 0.2% by weight of indium. The support obtained thereby had a BET surface of 210 m²/g.

A catalyst E was prepared on this support, aiming for the same platinum and chlorine contents as in Example 1. The catalyst E obtained after calcining contained 0.31% by weight of platinum, 0.31% by weight of tin, 0.22% by weight of indium, 0.40% by weight of phosphorus and 1.02% by weight of chlorine.

### Example 6

### Comparative

### Preparation of a Catalyst F

### Pt—In/(Al₂O₃—Sn—P)—Cl

A support was prepared, aiming for the same quantities of tin and phosphorus as in Example 3. The support obtained thereby had a BET surface of 180 m²/g.

A catalyst F was prepared on this support, aiming for 0.3% by weight of platinum, 0.3% by weight of indium and 1% by weight of chlorine on the final catalyst.

400 cm³ of an aqueous solution of hexachloroplatinic acid and hydrochloric acid was added to 100 g of alumina support containing tin and phosphorus. It was left in contact for 4 hours then drained. It was dried at 90° C. then brought into contact with 200 cm³ of an aqueous solution of indium nitrate in the presence of hydrochloric acid. It was left in contact for 4 hours, drained, dried at 120° C. then calcined for 2 hours at 500° C. in a flow of air of 100 litres per hour, with a temperature ramp-up of 7° C. per minute. The catalyst F obtained after calcining contained 0.30% by weight of platinum, 0.32% by weight of tin, 0.29% by weight of indium, 0.41% by weight of phosphorus and 1.04% by weight of chlorine.

### Example 7

### Comparative

### Preparation of a Catalyst G

### Pt—In—P/(Al₂O₃—Sn)—Cl

A support was prepared, aiming for the same quantities of tin as in Example 1.

A catalyst G was prepared on this support, aiming for 0.3% by weight of platinum, 0.3% by weight of indium, 0.4% by weight of phosphorus and 1% by weight of chlorine on the final catalyst. The support obtained thereby had a BET surface of 209 m²/g.

400 cm³ of an aqueous solution of hexachloroplatinic acid and hydrochloric acid was added to 100 g of alumina support containing tin and phosphorus. It was left in contact for 4 hours then drained. It was dried at 90° C. then brought into contact with 200 cm³ of an aqueous solution of indium nitrate and phosphoric acid in the presence of hydrochloric acid. It was left in contact for 4 hours, drained, dried at 120° C. then calcined for 2 hours at 500° C. in a flow of air of 100 litres per hour, with a temperature ramp-up of 7° C. per minute. The catalyst G obtained after calcining contained 0.30% by weight of platinum, 0.31% by weight of tin, 0.33% by weight of indium, 0.38% by weight of phosphorus and 1.05% by weight of chlorine.

### Example 8

### In Accordance with the Invention

### Preparation of a Catalyst H

### Pt—Sn/(Al₂O₃—Sn—In—P)—Cl

A support was prepared, aiming for the same quantities of indium and phosphorus as in Example 4, but with 0.2% by weight of tin. The support obtained thereby had a BET surface of 182 m²/g.

A catalyst H was prepared on this support by depositing 0.35% by weight of platinum, a supplemental 0.2% by weight of tin in order to obtain 0.4% by weight of tin and 1% by weight of chlorine on the final catalyst.

400 cm³ of an aqueous solution of hexachloroplatinic acid and hydrochloric acid was added to 100 g of alumina support containing tin and indium. It was left in contact for 4 hours then drained. It was dried at 90° C. then brought into contact with 200 cm³ of an aqueous solution of tin tetrachloride in the presence of hydrochloric acid. It was left in contact for 4 hours, drained, dried at 120° C. then calcined for 2 hours at 500° C. in a flow of air of 100 litres per hour, with a temperature ramp-up of 7° C. per minute. The catalyst H obtained after calcining contained 0.36% by weight of platinum, 0.41 by weight of tin, 0.29% by weight of indium, 0.41% by weight of phosphorus and 0.99% by weight of chlorine.

### Example 9

### In Accordance with the Invention

### Preparation of a Catalyst I

### Pt—Sn/(Al₂O₃—Sn—Sb—P)—Cl

An alumina bead support containing 0.1% by weight of tin, 0.4% by weight of antimony and 0.4% by weight of phosphorus and with a mean diameter of 1.2 mm was prepared in a manner similar to that described in Example 4 using tin dichloride, gallium nitrate and phosphoric acid. The support obtained thereby had a BET surface of 191 m²/g.

A catalyst I was prepared from said support, with the same quantities of platinum, tin and chlorine as in Example 7. Catalyst G obtained after calcining contained 0.29% by weight of platinum, 0.30% by weight of tin, 0.32% by weight of indium, 0.42% by weight of phosphorus and 1.10% by weight of chlorine.

### Example 10

### Mössbauer Characterizations of Catalysts A to I

Catalysts A to I were reduced in a flow of hydrogen at 450° C. for two hours and transferred, without the ingress of air, into a sealed glass cell adapted to the Mössbauer apparatus. The values for the isomer shifts and quadripole splitting values for the catalysts A to I of Examples 1 to 9 were determined using the methods described in the description and are indicated in Table 1.

TABLE 1
Values for isomer shifts and quadripole splitting of catalysts A to I

| | Mössbauer characterization | | | |
|---|---|---|---|---|
| | δ | Δ | | |
| Catalyst | (mm/s) | (mm/s) | % | Attribution |
| A | 0.05 | 0.79 | 64 | Sn^{IV} |
| | 0.20 | 1.60 | 11 | Sn^{IV} |
| | 2.64 | 1.30 | 11 | Sn^{II} |
| | 3.60 | 1.60 | 14 | Sn^{II} |
| B | 0.01 | 0.83 | 69 | Sn^{IV} |
| | 2.28 | 1.59 | 16 | Sn^{II} |
| | 3.29 | 2.04 | 15 | Sn^{II} |
| C | 0.05 | 0.78 | 52 | Sn^{IV} |
| | 0.08 | 1.25 | 23 | Sn^{IV} |
| | 2.51 | 1.21 | 11 | Sn^{II} |
| | 3.50 | 1.90 | 14 | Sn^{II} |
| D | 0.03 | 0.88 | 81 | Sn^{IV} |
| | 3.65 | 1.40 | 13 | Sn^{II} |
| | 1.90 | 0.40 | 6 | Sn⁰ |
| | | | | (in PtSn alloy) |
| E | 0.02 | 0.89 | 79 | Sn^{IV} |
| | 3.72 | 1.38 | 15 | Sn^{II} |
| | 1.88 | 0.44 | 6 | Sn⁰ |
| | | | | (in PtSn alloy) |
| F | 0.05 | 0.79 | 55 | Sn^{IV} |
| | 0.10 | 1.24 | 23 | Sn^{IV} |
| | 2.57 | 1.28 | 12 | Sn^{II} |
| | 3.52 | 1.88 | 15 | Sn^{II} |
| G | 0.05 | 0.79 | 47 | Sn^{IV} |
| | 0.21 | 1.60 | 28 | Sn^{IV} |
| | 2.63 | 1.28 | 13 | Sn^{II} |
| | 3.61 | 1.61 | 12 | Sn^{II} |
| H | 0.04 | 0.85 | 78 | Sn^{IV} |
| | 3.58 | 1.49 | 15 | Sn^{II} |
| | 1.90 | 0.38 | 7 | Sn⁰ |
| | | | | (in PtSn alloy) |
| I | 0.03 | 0.89 | 83 | Sn^{IV} |
| | 3.59 | 1.41 | 12 | Sn^{II} |
| | 1.91 | 0.40 | 5 | Sn⁰ |
| | | | | (in PtSn alloy) |

### Example 11

### Evaluation of Performances of Catalysts A to I in Catalytic Reforming

Samples of the catalysts prepared as described in Examples 1 to 9 were placed in a reaction bed adapted to the conversion of a hydrocarbon feed of the naphtha type derived from oil distillation. This naphtha had the following composition (by weight):
52.6% of paraffinic compounds;
31.6% of naphthenes;
15.8% of aromatic molecules;
   with a total density of 0.759 g/cm³.

The research octane number of the feed was close to 55.

After loading into the reactor, the catalysts were activated by heat treatment in an atmosphere of pure hydrogen for a period of 2 h at 490° C.

The catalytic performances were evaluated under reforming reaction conditions in the presence of hydrogen and the naphtha described above. In particular, the conditions for use and for comparison of the catalysts were as follows:
pressure of the reactor kept at 8 bar g (0.8 MPa g);
flow rate of feed of 2.0 kg/h per kg of catalyst;
hydrogen/hydrocarbon molar ratio of feed: 4.

The comparison was made at iso-quality of research octane number of the liquid effluents (also termed reformates) resulting from catalytic conversion of the feed. The comparison was carried out for a research octane number of 104.

TABLE 2
Catalyst performances

| | C5+ yield at | C4− yield at | | |
|---|---|---|---|---|
| | 148 h | 148 h | Deactivation | Coke |
| Catalyst | (% by weight) | (wt %) | (° C./h) | (% by weight/h) |
| A | 88.38 | 8.37 | +0.088 | +0.034 |
| B | 88.79 | 8.05 | +0.140 | +0.038 |
| C | 88.29 | 8.39 | +0.099 | +0.033 |
| D | 89.36 | 7.34 | +0.084 | +0.026 |
| E | 89.12 | 7.58 | +0.099 | +0.030 |
| F | 88.64 | 8.11 | +0.102 | +0.034 |
| G | 88.51 | 8.23 | +0.092 | +0.038 |
| H | 89.22 | 7.45 | +0.085 | +0.029 |
| I | 89.25 | 7.48 | +0.089 | +0.029 |

The catalysts of the invention (catalysts D, E, H and I) had improved selectivity (higher C5+ yield) and improved stability (smaller quantities of coke).

1. A catalyst comprising at least one metal M from the platinum group, tin, a phosphorus promoter, a halogenated compound, a porous support and at least one promoter X1 selected from the group constituted by gallium, indium, thallium, arsenic, antimony and bismuth, said catalyst in the reduced form having, in ¹¹⁹Sn Mössbauer spectroscopy, a signal with a quadripole splitting value in the range 0 to 0.45 mm/s and an isomer shift, IS, in the range 1.5 to 2.4 mm/s with respect to CaSnO₃, said signal representing in the range 1% to 30% of the total area of the signals.

2. A catalyst according to claim 1, in which the atomic ratio Sn/M is in the range 0.5 to 4.0.3.

3. A catalyst according to claim 1, in which the ratio X1/M is in the range 0.1 to 5.0.

4. A catalyst according to claim 1, in which the ratio P/M is in the range 0.2 to 30.0.

5. A catalyst according to claim 1, in which the quantity of metal M is in the range 0.01% to 5% by weight.

6. A catalyst according to claim 1, in which the metal M is platinum or palladium.

7. A catalyst according to claim 1, in which the halogenated compound is selected from the group constituted by fluorine, chlorine, bromine and iodine.

8. A catalyst according to claim 1, in which the quantity of halogenated compound is in the range 0.1% to 15.0% by weight.

9. A catalyst according to claim 1, in which the halogenated compound is chlorine and the chlorine content is in the range 0.1% to 5.0% by weight.

10. A catalyst according to claim 1, in which the support comprises at least one oxide selected from the group constituted by oxides of magnesium, titanium, zirconium, aluminium and silicon.
